(19) United States
(12) Patent Application Publication
(10) Pub. No.: US 2024/0069597 A1
(43) Pub. Date: Feb. 29, 2024

(54) Smart Wearable Electric Devices and Methods for Communication

(71) Applicant: Phyllis Jager, New York, NY (US)

(72) Inventor: Phyllis Jager, New York, NY (US)

(21) Appl. No.: 18/387,441

(22) Filed: Nov. 6, 2023

Related U.S. Application Data
(63) Continuation of application No. 17/333,064, filed on May 28, 2021, now abandoned.

(51) Int. Cl. G06F 1/16; G10L 13/02; G10L 15/18; G10L 15/22

(52) U.S. Cl. CPC G06F 1/163; G10L 13/02; G10L 15/18; G10L 15/22; G10L 2015/221; G10L 2015/223

(57) ABSTRACT

This disclosure generally relates to smart-phone and communication device which is wireless and chargeable. The device can be controlled through voice and embedded with software for a number of functionalities. The smartphone named Chear can respond to voice commands, access databases through internet connectivity, and create a novel communication stream that informs both the wearer and those around them. The smart-phone invention has a protective covering of rubber and plastic to protect the device from possible damages. The invention can be connected to the World Wide Web (internet) and can perform live streaming for audio and video, the complete functionality of texting including reading, writing and sending messages and e-mails. The device can operate via speakerphone. As a smart gadget, it can access the Internet, take voice commands, transfer/exchange/store cloud-based data, and be transferred to any other device through a USB port. It includes the functionalities of a camera and is GPS enabled.

### BACKGROUND

### Field of the Invention

The present invention relates to a hands-free, wireless, wearable, in-car smart-phone and electric power charging station. The invention is a small portable communication device with all functionalities of mobile phone, audio and music devices, which can be controlled through voice and embedded with software for a number of functionalities. The invention also relates to a chargeable device, which is chargeable through an AC port as well. The invention is the broad category of smartphones and a complete functioning smart communication device in a pattern of earphones and a built-in microphone. The invention can be categorized as wireless smart tech gadgets and devices.

Aspects of the present invention relate more particularly to use the trend—as having all in one feature for a small gadget. The invention supports all audio, video, and communication facilities and keeps its uniqueness as the complete smart phone embedded with all other features. In short, the invention is in the shape of a wireless earphone, which can be deemed as “Emotional Mirror” technology—working on sensors and voice-based command. The invention is an addition to a fast and healthy lifestyle and the smart phone and audio technology.

### Description of the Related Art

The term ‘smart-phone’ refers to a multi-functional mobile phone handset that packs everything from a camera and web browser to a high-density display. Other key features of a smart-phone include masses of storage space, micro SD card slots to allow you to upgrade further, and intuitive touchscreen user interfaces to access all the great functions of the handset quickly and easily. The use of smart-phones is unlimited in today's technological world. The benefit originally started from transistors and Walkman has extended to cell phones, PDAs, TVs, MP3, Ipad/phones, and now not limited to internet connectivity enabled with software to act as a player.

A typical and standard pattern of smart-phones are the ones that come in a phone shape irrespective of the size. Consumers use wireless earphones or Bluetooth to operate them without picking them in hand by placing wireless earphones or Bluetooth devices that plug into the user's ear canal. Users of one of these devices (earphones/Bluetooth) would plug the headset into the device to privately listen to the audio signals output from the device or to listen without disturbing others around the user. The conventional headsets used to have one or two earphones and may include a microphone for applications where user audio input is needed, for example, for use with a telephone. A user can often wear the headset when listening to an audio signal, even when not. The traditional smart-phone and mobile communication sets were usually large and were not wireless, along with not having the facility of internet connectivity and work on voice command.

Multiple types of advancements have been seen in mobile devices and their utilities by looking at the prior art. For instance, a Self-powered wireless communication device and method of use bearing US patent 2,003,0087677A1 is issued to Milocon Corp. The present invention relates to a power generating mechanism with a movable element mounted to a wireless communication device. The movement of the movable component generates electricity via the power generating mechanism to allow a user to make a phone call when a battery of the device is discharged. The power generating mechanism can be a mechanical type or a piezoelectric type and involve a keypad, a battery cover, an antenna, a crank, or a keypad cover. The wireless device can also include an auxiliary power source and a switch to activate the auxiliary power source when needed, and a light adapted to illuminate when a call is received.

Another patent on Endless powered anywhere cellphone system bearing U.S. Pat. No. 7,289,831B2 is issued to Nick Trozzi. The patent is on a cellphone system, cellphone flip or non-flip types (10) removable or collapsible hand crank to dynamo (12) external dynamo attachment (14) external solar cell attachment (16) dynamo and solar cell attachment jack (18) solar cells (20) cellphonc charging dock (22).

Another patent on Charger for cellular phone bearing US patent 2,005,0024011A1 is issued to Inventec Appliances Corp. The present invention is to provide a charger for the cellular phone comprising a body having a well and a battery compartment on its opposite surfaces, at least one pair of positive and negative terminals in the battery compartment, at least one pair of electrical contacts on the well and a charging circuit inside the body being electrically coupled to and the electrical connections and terminals respectively. When the cellular phone is rested on the well, the charging plugs of the cellular phone are electrically connected to the electrical contacts. Thus, the charging circuit is adapted to automatically supply power from either the external power source or the cells (or batteries) received in the battery compartment to charge at least one electrical energy storage element in the cellular phone.

Another US patent, 2,006,0108976A1, on a non-contact charging device is issued to Tiger Chen. The non-contact charging device includes a charging seat and a receiving end. The invention is characterized by the charging centre being disposed of with an active coil and a power circuit. The receiving end is provided with an inductive coil, a conversion circuit, and an electric cell at an interior thereof. Using the structures described above, electric power is transmitted from the charging seat to the receiving end using electromagnetic induction by approaching the active coil with the inductive coil. Without requiring a design of connecting terminals, terminal damages and poor contact is prevented from reducing production cost.

Multiple inventions have been proposed in prior art regarding bringing advancement and enhanced utility regarding advances in selfie devices. Furthermore, the utilization of these systems in daily life is pretty cumbersome and non-effective. Also, the features of these utility systems are somewhat limited.

In contrast, it is an object of the invention to create a smartphone with the latest miniaturising trend, embedded with the latest software, having all in one features giving all functionalities of a typical smart-phone in a share of a small wireless gadget with a look of a wireless earphone. In actuality, the invention is a smart-phone and complete communication device that can respond to everything from an individual's emotional state to their interactions with others with light, colour, and opacity; these adaptive materials create a novel communication stream that informs both the wearer and those around them.

### SUMMARY

In light of the disadvantages of the prior art, the following summary is provided to understand some of the innovative features unique to the present invention and is not intended to be a complete description. A full appreciation of the various aspects of the invention can be gained by taking the entire specification, claims, drawings, and abstract as a whole.

Considering the advances in technology, the primary objective of the invention relates to the latest trend of miniaturizing, embedded with the latest software, having all in one features giving all functionalities of a typical smart-phone in a share of a small wireless gadget with a look of a wireless earphone. In actuality, the invention is a smart-phone and complete communication device that can respond to everything from an individual's emotional state to their interactions with others with light, color, and opacity; these adaptive materials create a novel communication stream that informs both the wearer and those around them.

It is also the objective of the invention to create a smartphone named “Chear”, which can recognize voice commands and analyze them, then perform the task and report back they can also shut down when not in use. It includes manually and voice-activated remote sensors, which can be used in place of the ‘wake word’.

It is further the objective of the invention to create the miniature smart phone, which is a hands-free, wireless, wearable, solar-powered, the solar chargeable smart phone that goes in the ear similarly to an ear bud. Despite having a unique shape and charging capacity with wireless and wearable features, it can perform all functions of a complete cell phone and a communication device. It also has all parts of an audio-video player. The invention named Chear can be connected to the World Wide Web (internet) and can perform live streaming for audio and video, the complete functionality of texting including reading, writing and sending messages and e-mails. The device can operate via a speaker phone. As a smart gadget, it can access the Internet, take voice commands, transfer/exchange/store cloud-based data, and be transferred to any other device through a USB port. It includes the functionalities of a camera and is GPS enabled. All possible skills for consumer convenience are embedded, giving the consumer all in one capability wireless smart-phone, which can be worn as an earphone.

This summary is provided merely for summarizing some example embodiments to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification and serve to illustrate further embodiments of concepts that include the claimed invention and explain various principles and advantages of those embodiments.

FIG. 1 shows the upper view of one embodiment of the wireless, wearable and chargeable smart-phone. It shows the earbud portion is to be worn in-ear. It also shows the estimated size of the phone in comparison to the earpiece. It offers its sleek round design with the earpiece embedded in it for two-way communication.

FIG. 2 shows the front view of the smart-phone, the part that would be inserted in the ear and part that would emit sound. It offers the design and ear resting position of the device.

FIG. 3 show the side-view of the smart-phone giving a closer view of the screen display. It provides the visibility and idea of the screen size and visibility of different functions. The figure provides the perspective of a phone with the phone indications.

FIG. 4 shows the same side view with a different display. The display is indicating an incoming call to be answered via voice connectivity or manual touching. The screen and image give a clear idea of the invention, which is like an earphone in shape but a smart-phone with multiple features.

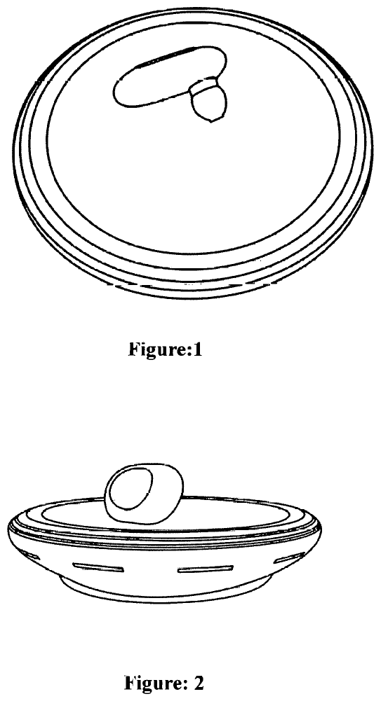

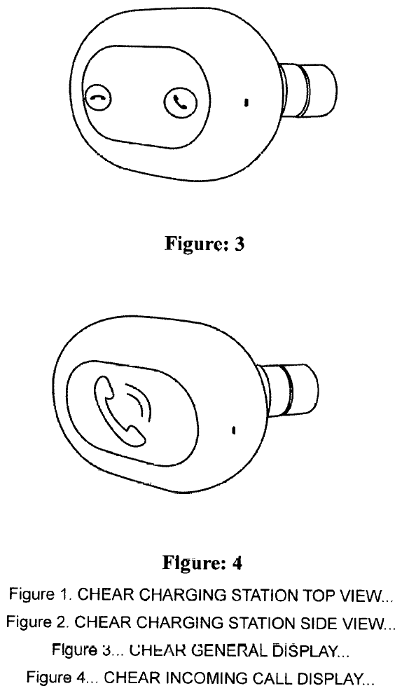

Skilled artisans will appreciate that elements in the figures are illustrated for simplicity and clarity and have not necessarily been drawn to scale. For example, the dimensions of some of the features in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting but rather as a basis for the claims and as a representative basis for teaching one skilled in the art to employ the present invention in virtually any appropriately detailed system, structure or manner.

In light of the disadvantages of the prior art, the following summary is provided to understand some of the innovative features unique to the present invention and is not intended to be a complete description. A full appreciation of the various aspects of the invention can be gained by taking the entire specification, claims, drawings, and abstract as a whole.

According to a first embodiment, the smart-phone, invented, is wireless and does not require connectivity through wires. It can work as a Bluetooth device but is not Bluetooth. Internet connectivity of the smart-phone (Chear) makes it effective in handling. The miniature phone will charge through an AC pin, and the device lights up when it gets full charge as an indication.

The newly invented wireless smart-phones, as per additional embodiments, can connect to any device and is not limited to specific players. It is wireless, so it is wire-free. Through the connectivity, it can play music from multiple devices and different software platforms. It can connect to smart phones, smart devices, and different IOS systems to play music or audio by connecting to them. It can connect to a number of apps and music players other than computer and software-enabled devices. It can connect to the internet for live streaming, web browsing, e-mails, GPS, traffic maps and connection to remote devices.

As per its further embodiments, the assembly is GPS enabled and can perform on automated voice directions in different turns and modes. The GPS feature will enable it to connect to live traffic, maps, satellites and servers for data streaming and downloading. The smart-phone can recognize voice commands and analyze them, then perform the task and report back; they can also shut down when not in use. The invention has this unique feature of working on voice command through micro-controlled chip and software.

Chear the wireless and wearable smart-phone has a camera for taking snaps and making videos. The device, through its camera, has the audio-video communications ability for teleconferencing and video calls. It also supports all social media apps for full functionality.

As per its preferred embodiments, the voice recognition capability is based on providing web services and enabled through a voice platform. As it is software-enabled, its functioning is linked with the server through World Wide Web. The device will even work if the signal strength of the internet is low. The invention gives good performance even at low latency, where factors like processing time, streaming, geo-disturbed service endpoints do not hinder the performance.

As per its additional embodiments, the device can give news and weather forecast from a variety of sources once it is connected to the internet. It can synchronize with radio stations to provide an update through internet connectivity. In the same context, earphones can play music directly from the Music accounts and have built-in support for streaming music services. The device provides support to thermostats and can play music from streaming services like Apple and Google Play. It can synchronize through a phone or tablet for playing the music if required.

It supports activities like listening to audio books and other online audio devices through streaming. As the device operates through internet connectivity and connects through a server, it can maintain voice-controlled alarms, timers, shopping and to-do lists, and access online articles. The latest wireless smart-phone responds to questions about items by connecting to the internet and other related databases and devices.

The invention, which is a wearable mobile phone and acts as a personal media player and mini communicator, has the capability of real-time two-way and multi-feed wireless voice, data and audio-video streaming, telecommunications, and teleconferencing, coordinated applications, and shared functionality between one or more wirelessly networked mobile devices or other paired or networked wired or wireless devices and optimized device and data management over multiple wired and wireless network connections.

An extensive collection of self-service APIs, Apps, tools, documentation, and code samples is available to get the facilitation of self-services mentioned above. The software can be updated, and more features can be added to customize the functionalities. The same can be used through connectivity to the internet and other devices.

As the device is internet-connected and operates through server-based software, overtime period, new versions and software releases will fix bugs and include enhanced functionality. The device will work on artificial intelligence and the device system can be updated through software and cloud networking, once connected to the internet.

It's a hot spot and wireless router supporting direct connect multi-device ad-hoc virtual private networking (VPN). Can use operating systems including Fire OS. Besides this, Wi-Fi tethering enables it to connect to a Wi-Fi hotspot on a mobile device, including public Wi-Fi. The invention also features an option to plug into a wall charger or USB outlet. Last but not least, the device includes 3d Spatial perception.

Chear operates via voice command and voice vibration. The smart-phone invention lets you talk back with an “ear microphone” that transmits your voice by picking up the vibrations in your ear canal. The earphone has built-in intelligence to choose among available network protocols while supporting various onboard and remote operational controls. This device does not need to sync with another instrument, headset, or handset of any kind.

The wearable smart-phone “Chear” can allow phone calls wirelessly and is a wireless smart phone (not Bluetooth connected. The smart-phone, as any standard smart phone, also has the feature to recharge through an AC outlet.

A pin-sized pointer stored in Chear's side shell will deliver a holographic display allowing easy viewing without the use of glasses. This facilitation is provided to overcome the small design. To facilitate the use to view the things in large mode and more clearly as to their suitability, the pointer is provided and the device for holographic displays.

The design factor of the smart-phone is in accordance to protect the small device from all shocks and damages. The smart-phone “Chear” has a combined blend of plastic and rubber that will produce a protective shell that will absorb shock and protect the Chear's screen. The invention comes with a full protection cover to maximize the protection of the screen against all possible follies of breaking or damage.

“Chear”, the new invention, provides a safety factor being hands-free as a convenience factor for all incoming and outgoing calls. The same includes facilitation during driving like a Bluetooth set.

The wireless smart-phone is an ergonomic, compact, and lightweight design, which does not require any unwanted bulk in driving space. The invention provides an efficient, stylish, wireless smart-phone, which can be charged on the way through the car charger or simply by plugging it into any port in your car.

The new invention provides a struggle free and minimizes accident risks against the inconvenience of big clumsy phones or wires while driving. The invention will bring a revolutionary new versatile smart-phone with premium-quality sound, ultra-powerful charging and long-lasting battery in a miniaturized phone set; the invention will shock the consumers once it is revealed or launched.

The ultra-lightweight and compact design means less clutter in your ever-important driving area. The flexible, bendable, earpiece based phone ensures a 100% comfortable and safe fit. It will ensure that no call is missed while being on the road and do it with state of the art noise and echo cancellation technology. Chear is an ultra-secure, secure fit which would suit men and women of all age groups and different demographics. Last but not least, the wireless phone would provide and prove to be the most secure fitting wireless phone acting as a wireless headset on the market and has sports audiophile-level sound with very to use features.

The Abstract of the Disclosure is provided to allow the reader to ascertain the nature of the technical disclosure quickly. It is submitted to understand that it will not be used to interpret or limit the scope or meaning of the claims. In addition, in the preceding Detailed Description, it can be seen that various features are grouped in various embodiments to streamline the disclosure. This method of disclosure is not to be interpreted as reflecting an intention that the claimed embodiments require more features than are expressly recited in each claim. Instead, as the following claims reflect, the inventive subject matter lies in less than all features of a single disclosed embodiment. Thus the following claims are hereby incorporated into the Detailed Description, with each claim standing on its own as a separately claimed subject matter.

1. A wireless smartphone device comprising:
one or more cameras;
one or more microphones configured to receive and transmit an audio signal;
a display; and
an earbud portion configured for insertion into the ear canal of a user.
